(19) United States
(12) Patent Application Publication
(10) Pub. No.: US 2016/0125217 A1
(43) Pub. Date: May 5, 2016

(54) BARCODE SCANNING SYSTEM USING WEARABLE DEVICE WITH EMBEDDED CAMERA

(71) Applicant: Hand Held Products, Inc., Fort Mill, SC (US)

(72) Inventor: Erik Todeschini, Camillus, NY (US)

(21) Appl. No.: 14/533,319

(22) Filed: Nov. 5, 2014

(51) Int. Cl. G06K 7/14; G06K 9/18; H04N 5/44

(52) U.S. Cl. CPC G06K 7/1404; H04N 5/44; G06K 9/183; G06K 9/18; G06K 2007/10534

(57) ABSTRACT

A smartwatch is provided with an embedded camera; barcode decoding software; a user interface system, the user interface system being provided with a visual display on the smartwatch; and a processor communicatively coupled to the camera, the user interface system, and the barcode decoding software. The processor is configured for a barcode scanning and decoding operation. The barcode scanning and decoding operation is configured for: triggering a view finder on the smartwatch, aligning a barcode in the view finder; capturing images of the barcode aligned in the view finder with the camera, feeding the barcode images to barcode decoding software; and sending the decoded barcode information to the visual display.

### FIELD OF THE INVENTION

The present invention relates to wearable devices with barcode scanning and decoding capability and the barcode scanning process and system on the wearable device platform.

### BACKGROUND

Generally speaking, smartwatches include embedded cameras. Many of the applications for using the camera images from a smartwatch are related to social media. Smartwatches may employ different operating systems (e.g., ANDROID™, iOS™, WINDOWS-PHONE™, etc.). These operating systems in conjunction with processors and wireless linking capability have not been exploited to their maximum potential with inventive applications.

Barcode scanning/decoding is often done with barcode-dedicated equipment. More recently, smartphones and tablets have been enabled to read some types of barcodes. For example, smartphones can scan a QR code that directs a browser to a website.

However, the capability of easily scanning, decoding, and displaying barcodes with a less bulky device in an intuitive way is still elusive.

Therefore, a need exists for a barcode scanning system which is not bulky, which is intuitive to use, is resident on a wearable device, and can communicate with, or be part of a larger system.

### SUMMARY

Accordingly, in one aspect, the present invention embraces a smartwatch with an embedded camera, which cooperatively works with barcode decoding software.

In another aspect, the present invention embraces a process for imaging, decoding, and displaying barcodes with a wearable device.

In yet another aspect, the present invention embraces a barcode scanning system resident on a wearable device.

In an exemplary embodiment, the present invention is comprised of a smartwatch provided with an embedded camera; barcode decoding software; a user interface system, the user interface system being provided with a visual display on the smartwatch; and a processor communicatively coupled to the camera, the user interface system, and the barcode decoding software. The processor is configured for a barcode scanning and decoding operation. The barcode scanning and decoding operation is configured for: triggering a view finder on the smartwatch, aligning a barcode in the view finder; capturing images of the barcode aligned in the view finder with the camera, feeding the barcode images to barcode decoding software; and sending the decoded barcode information to the visual display.

In another aspect, the smartwatch is provided with a wireless communication system. The processor is communicatively coupled to wireless communication system.

In another aspect, the processor is further configured for feeding the barcode images to a remote electronic device and for receiving decoded barcode information from the remote electronic device.

In a further aspect, the processor is configured for sharing and receiving data via RF links with remote electronic devices.

In yet another aspect, the smartwatch has an operating system. The processor is an application within the operating system.

In another aspect, the barcode decoding software is capable of discerning different types of barcode symbologies and optical character recognition text.

In another exemplary embodiment, the present invention comprises a process for imaging and decoding a barcode with a wearable device. The process is comprised of the following steps: triggering a wearable device to display a view finder; aligning a barcode in the view finder; capturing images of the barcode with a camera on the wearable device; feeding camera frames of the barcode images to barcode decoding software; decoding the barcode; sending the decoded barcode information to the wearable device display; and displaying decoded barcode information on the wearable device display.

In another aspect, the wearable device is a smartwatch.

In another aspect, the feeding step includes transmitting the barcode images to a remote device having the barcode decoding software.

In yet another aspect, the barcode decoding software is resident on the wearable device.

In another aspect, the triggering step is accomplished by a physical act by a wearer of the wearable device. The physical acts to trigger the display can include a voice command, a swiping motion of a stylus on the wearable device display, a display touch, a touch gesture, and a physical motion of the wearable device.

In another aspect, the triggering step is accomplished by a signal from a remote device to the wearable device.

In another aspect, the sending step further includes sending the decoded barcode information to a remote electronic device for display.

In another aspect, the sending step further includes sending the decoded barcode information to a remote device where the decoded barcode information is used for business logic purposes, but not necessarily displayed.

In another aspect, the process further includes the step of: notifying a wearer of the wearable device of a successful decoding of the barcode. The notifying step being accomplished by an indicator. The indicator can include an audible signal from the wearable device, a visual signal on the display of the wearable device, a haptic response from the wearable device and an audible signal from a remote device. The remote device is linked to the wearable device via an RF link.

In yet another exemplary embodiment, the present invention provides for a barcode scanning system which includes a smartwatch provided with an embedded camera, a user interface visual display, and an operating system which communicatively couples the user interface and the embedded camera. The barcode scanning system further includes decoding software. The decoding software is communicatively linked to the operating system. The operating system is configured for (i) triggering a view finder on the smartwatch visual display, (ii) aligning a barcode in the view finder; (iii) capturing images of the barcode aligned in the view finder with the camera, (iv) feeding the barcode images to the decoding software; and (v) sending the decoded barcode information to the visual display.

In another aspect of the barcode scanning system of the present invention, the decoding software is resident on the smartwatch.

In another aspect, the decoding software is on a remote electronic device.

In yet another aspect, the decoding software is capable of discerning different types of barcode symbologies and optical character recognition text.

In another aspect, triggering the viewfinder is initialized by a wearer of the smartphone by a physical action. The physical action can include a voice command, a swiping motion of a stylus on the smartwatch visual display, a display touch, a touch gesture, and a physical motion of the wearable device.

In another aspect, the operating system is communicatively linked to at least one remote electronic device via an RF signal.

In another aspect, triggering the viewfinder is initialized by a signal from a remote device to the operating system of the smartwatch.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 depicts a block diagram of a smartwatch in accordance with the present invention.

FIG. 2 depicts a flowchart of a barcode imaging and decoding process on a wearable device according to the present invention.

### DETAILED DESCRIPTION

The present invention embraces a wearable device, a process, and a system for imaging, decoding, and displaying barcodes.

The present invention will now be described more fully hereinafter with reference to the accompanying drawings in which preferred embodiments of the invention are shown. This invention however may be embodied in many different forms and should not be construed as limited to the embodiments set forth herein. In the drawings, like numbers refer to like elements throughout.

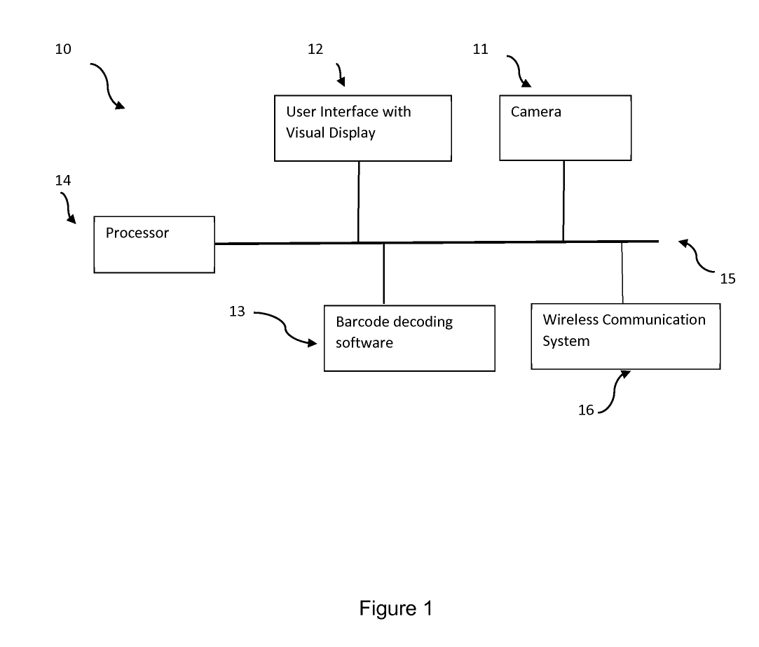

Referring to FIG. 1, in an exemplary embodiment of the present invention, a smartwatch 10 is provided with an embedded camera 11, a user interface 12 which includes a visual display, barcode decoding software 13, and a processor 14. The processor 14 communicatively links the camera 11, the user interface 12, and the barcode decoding software 13. The processor 14 may be an application in an operating system (not shown) of the smartwatch 10. The smartwatch 10 may be provided with a system bus 15 which assists the processor 14 to be communicatively linked to other components. There may also be other interface circuits and components, such as memory (not shown), and the like. The smartwatch 10 may also be provided with a wireless communication system 16. The processor 14 is communicatively linked to the wireless communication system 16. The processor 14 is configured for a process of scanning or imaging and decoding a barcode. The processor 14 is configured to trigger the user interface 12 to initialize a view finder on the visual display. The wearer of the smartwatch 10 then aligns the barcode in the visual display 12. The camera 11 captures images of the barcode. These images are sent to barcode decoding software 13. The barcode decoding software 13 is shown in the Figure as being resident on the smartwatch 10. However, the barcode decoding software 13 may be on a remote electronic device (not shown) instead of or in addition to being resident on the smartwatch 10. If the barcode decoding software 13 is on a remote electronic device, the processor 14 is configured to send and receive information via the wireless communication system 17 so that the barcode images can be sent to remote barcode decoding software, and decoded barcode information can be received on the smartwatch 10 and displayed on the user interface 12.

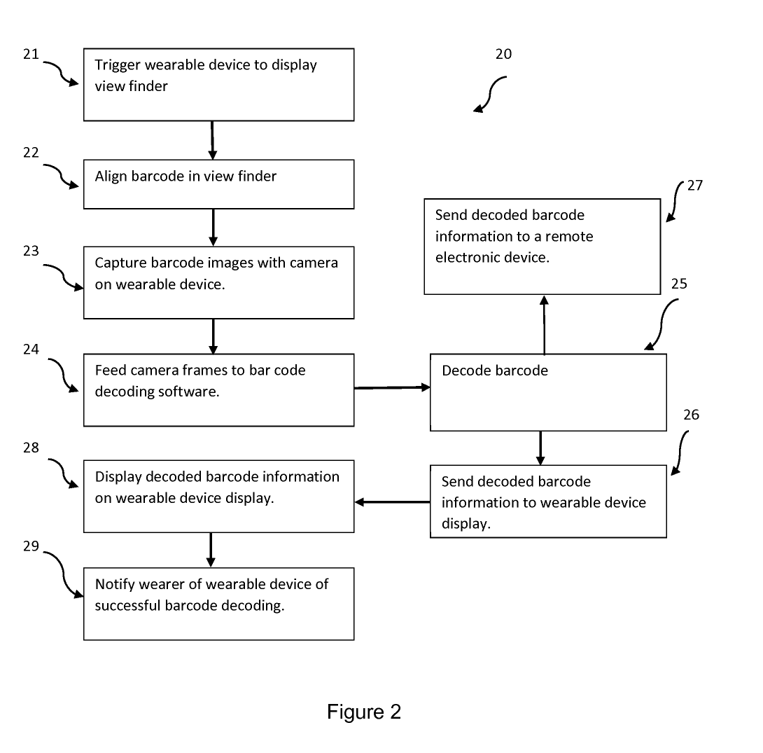

Referring now to FIG. 2, in another exemplary embodiment of the present invention, a process 20 for imaging and decoding a barcode with a wearable device is provided. The wearable device is preferably a smartwatch, for example, the smartwatch 10 of FIG. 1. The process 20 begins with step 21, triggering the smartwatch to display a view finder. The triggering step may be accomplished by a physical action of the smartwatch wearer. For example, the smartwatch wearer may give a voice command, make a swiping motion with a stylus on the smartwatch display, make a display touch, make a touch gesture, or make a physical motion of the smartwatch, like shaking the smartwatch. Alternatively, the triggering step 21 may be initialized by a signal to the smartwatch from a remote electronic device.

After the view finder is displayed, in step 22 the wearer of the smartwatch aligns the barcode to be read in the view finder. Images of the barcode are captured in step 23. As is known in the art, the camera on the smartwatch is provided with focusing and zooming capability. In step 24 the camera frames of the barcode are send to barcode decoding software, which may resident on the smartwatch, and/or on a remote electronic device. The barcode is decoded in step 25. The decoded barcode information is sent, in step 26 to the smartwatch visual display. Alternatively, or in addition to step 26, the decoded barcode information may be sent in step 27 to a remote electronic device for display, for storage in memory, or for some other purpose as in a business logic application. The remote electronic device, for example, may be a smartphone or a laptop computer, or any wireless enabled device.

In step 28, the decoded barcode information is displayed on the visual display of the smartwatch. Step 29 the smartwatch notifies the wearer that the barcode has been decoded successfully. This notification could be in the form of a visual or audio indicator, for example, the indicator may be a visual signal from the smartwatch display, an audio signal from the smartwatch, a haptic response form the smartwatch, or even an audible signal from a remote device.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning
Module Employing an Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923 for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTION CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 29/486,759 for an Imaging Terminal, filed Apr. 2, 2014 (Oberpriller et al.);
U.S. patent application Ser. No. 29/492,903 for an INDICIA SCANNER, filed Jun. 4, 2014 (Zhou et al.); and
U.S. patent application Ser. No. 29/494,725 for an IN-COUNTER BARCODE SCANNER, filed Jun. 24, 2014 (Oberpriller et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A smartwatch comprising:
a camera;
barcode decoding software in the smartwatch;
a user interface system, the user interface system being provided with a visual display on the smartwatch; and
a processor communicatively coupled to the camera, the user interface system, and the barcode decoding software, the processor being configured for a barcode scanning and decoding operation in the smartwatch; the barcode scanning and decoding operation in the smartwatch being configured for:
triggering a view finder on the smartwatch;
aligning a barcode in the view finder;
capturing images of the barcode aligned in the view finder with the camera;
feeding the barcode images to barcode decoding software in the smartwatch; and
sending the decoded barcode information to the visual display.

2. The smartwatch of claim 1, further comprising a wireless communication system, the processor communicatively coupled to the wireless communication system.

3. (canceled)

4. The smartwatch of claim 1, wherein the processor is further configured for sharing and receiving data via RF links with remote electronic devices.

5. The smartwatch of claim 1, further comprising an operating system, wherein the processor runs an application within the operating system.

6. The smartwatch of claim 1, wherein the barcode decoding software is capable of discerning different types of barcode symbologies and optical character recognition text.

7. A process for imaging and decoding a barcode with a wearable device, comprising:
triggering a wearable device to display a view finder;
aligning a barcode in the view finder;
capturing images of the barcode with a camera on the wearable device;
feeding camera frames of the barcode images to barcode decoding software in the wearable device;
decoding the barcode in the wearable device;
sending the decoded barcode information to the wearable device display; and
displaying decoded barcode information on the wearable device display.

8. The process of claim 7, wherein the wearable device is a smartwatch.

9. (canceled)

10. (canceled)

11. The process of claim 7, wherein the triggering step is accomplished by a physical act by a wearer of the wearable device, the physical act being selected from a voice command, a swiping motion of a stylus on the wearable device display, a display touch, a touch gesture, and a physical motion of the wearable device.

12. The process of claim 7, wherein the triggering step is accomplished by a signal from a remote device to the wearable device.

13. The process of claim 7, wherein the sending step further includes sending the decoded barcode information to a remote electronic device for display.

14. The process of claim 7, wherein the sending step further includes sending the decoded barcode information to a remote device.

15. The process of claim 7, further comprising the step of: notifying a wearer of the wearable device of a successful decoding of the barcode, the notifying step being accomplished by an indicator selected from an audible signal from the wearable device, a visual signal on the display of the wearable device, a haptic response from the wearable device and an audible signal from a remote device, the remote device being linked to the wearable device via an RF link.

16. A barcode scanning system comprising:
a smartwatch, the smartwatch provided with an embedded camera, a user interface visual display, and an operating system which communicatively couples the user interface and the embedded camera;
decoding software in the smartwatch, the decoding software being communicatively linked to the operating system;
the operating system being configured for:
triggering a view finder on the smartwatch visual display;
aligning a barcode in the view finder;
capturing images of the barcode aligned in the view finder with the camera;
feeding the barcode images to the decoding software in the smartwatch; and
sending the decoded barcode information to the visual display.

17. (canceled)

18. (canceled)

19. The barcode scanning system of claim 16, wherein the decoding software is capable of discerning different types of barcode symbologies and optical character recognition text.

20. The barcode scanning system of claim 16, wherein triggering the viewfinder is be initialized by a wearer of the smartwatch by a physical action, the physical action being selected from a voice command, a swiping motion of a stylus on the smartwatch visual display, a display touch a touch gesture, and a physical motion of the wearable device.

21. The barcode scanning system of claim 16, wherein the operating system is communicatively linked to at least one remote electronic device via an RF signal.

22. The barcode scanning system of claim 21, wherein triggering the viewfinder is initialized by a signal from a remote device to the operating system of the smartwatch.
